(19) United States
(12) Patent Application Publication
(10) Pub. No.: US 2014/0065495 A1
(43) Pub. Date: Mar. 6, 2014

(54) METAL-AIR BATTERY

(71) Applicant: Keiichi MINAMI, Suntou-gun (JP)

(72) Inventor: Keiichi MINAMI, Suntou-gun (JP)

(73) Assignee: TOYOTA JIDOSHA KABUSHIKI KAISHA, Toyota-shi (JP)

(21) Appl. No.: 14/016,606

(22) Filed: Sep. 3, 2013

(30) Foreign Application Priority Data
Sep. 4, 2012 (JP) 2012-193971

(51) Int. Cl. H01M 12/02

(52) U.S. Cl. CPC H01M 12/02
USPC 429/403

(57) ABSTRACT

A metal-air battery that includes a positive electrode layer, a negative electrode layer, and an electrolyte layer between the positive electrode layer and the negative electrode layer, in which a metal porous body is further provided between the negative electrode layer and the electrolyte layer.

### INCORPORATION BY REFERENCE

The disclosure of Japanese Patent Application No. 2012-193971 filed on Sep. 4, 2012 including the specification, drawings and abstract is incorporated herein by reference in its entirety.

### BACKGROUND OF THE INVENTION

1. Field of the Invention

The invention relates to a metal-air battery that uses oxygen as a positive electrode active material.

2. Description of Related Art

Along with recent popularization and advance of devices such as portable telephones, a high capacity battery as a power supply thereof is in demand. Under such an environment, a metal-air battery is attracting an attention as a high capacity battery that has a high energy density and is superior to a lithium ion battery that is generally used at the present time. In the metal-air battery, in an air electrode, oxygen in air is used as a positive electrode active material to conduct a redox reaction of the oxygen, on the other hand, in a negative electrode, a redox reaction of a metal configuring the negative electrode is conducted, and thereby charging or discharging is realized. (see National Institute of Advanced Industrial Science And Technology (AIST), “development of high performance lithium-air battery having novel structure”, “online”, press-released on Feb. 24, 2009, “search on Aug. 19, 2011”, internet <http://www.aist.go.jp/aist_j/press_release/pr2009/pr20090224/pr20090224.html>).

However, a metal-air battery has a problem that during charge, on a surface of a negative electrode layer, dendrites precipitate, and as the charge/discharge is repeated, the dendrites precipitate and grow to induce degradation of a battery capacity or internal short-circuiting to degrade a charge/discharge efficiency. When, as a negative electrode material, a lithium-containing material such as metal lithium or a lithium alloy, in particular, metal lithium is used a high energy density and voltage can be obtained. However, in this case, dendrites tend to precipitate and grow, and the above-described problem becomes particularly serious.

In order to hinder the dendrites from precipitating and growing on a surface of a negative electrode layer containing lithium, a nonaqueous electrolyte battery in which an interfacial layer formed of amorphous carbon is disposed between a negative electrode layer and a solid electrolyte has been proposed (see Japanese Patent Application Publication No. 2011-086554 (JP 2011-086554 A)).

However, when the interfacial layer formed of amorphous carbon is disposed between the negative electrode layer and the solid electrolyte as disclosed in JP 2011-086554 A, since lithium ions are inserted in and detached from an amorphous carbon layer that is the interfacial layer, cycle characteristics degradation due to a side reaction and expansion and contraction of the interfacial layer tends to occur.

### SUMMARY OF THE INVENTION

Accordingly, a metal-air battery having less cycle degradation and high charge/discharge efficiency is in demand,

A metal-air battery that is one aspect of the present invention has a structure in which a metal porous body is disposed between a negative electrode layer and an electrolyte layer.

A metal-air battery that is another aspect of the present invention is a metal-air battery including: a positive electrode layer; a negative electrode layer; and an electrolyte layer between the positive electrode layer and the negative electrode layer, further including a metal porous body between the negative electrode layer and the electrolyte layer.

According to the aspects of the present invention, a metal-air battery having a high charge/discharge efficiency can be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional schematic view of an electrode section contained in a metal-air battery according to the present invention;

FIG. 2 is a cross-sectional schematic view of an electrode section contained in a metal-air battery according to a related art of the present invention; and

FIG. 3 is a cross-sectional schematic view of one example of an electrochemical cell containing a metal-air battery according to the present invention.

### DETAILED DESCRIPTION OF EMBODIMENTS

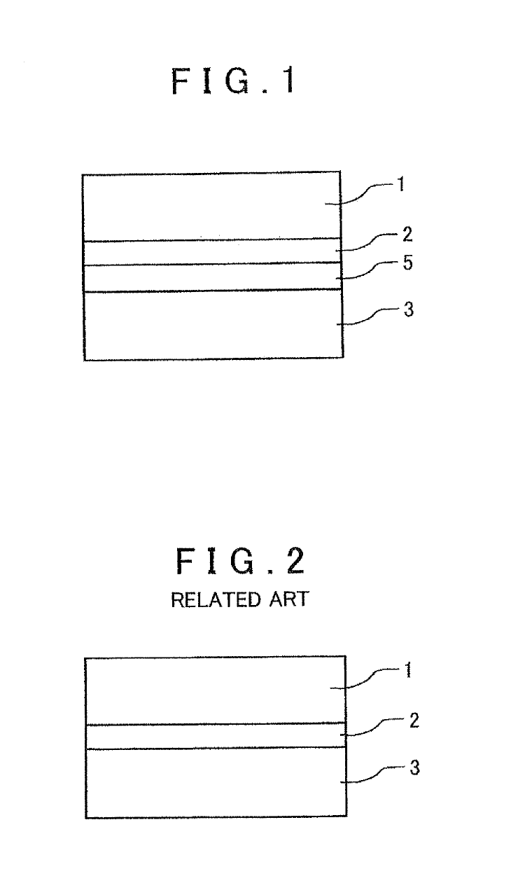

FIG. 1 shows a cross-sectional schematic view of an electrode section contained in a metal-air battery according to the present invention, and FIG. 2 shows a cross-sectional schematic view of an electrode section contained in a metal-air battery according to a related art of the present invention.

The electrode section contained in the conventional metal-air battery includes a positive electrode (air electrode) layer 1, a negative electrode layer 3, and an electrolyte layer 2 between the positive electrode layer 1 and the negative electrode layer 3. By contrast, the electrode section contained in the metal-air battery according to the present invention includes the positive electrode (air electrode) layer 1, the negative electrode layer 3, and the electrolyte layer 2 between the positive electrode layer 1 and the negative electrode layer 3, and further includes a metal porous body 5 between the negative electrode layer 3 and the electrolyte layer 2.

In order to hinder an electric current from concentrating on a lithium negative electrode surface and to hinder generation of dendrites, use of coating has been proposed. As a coating material, an electrode material of a lithium ion secondary battery such as carbon has been used. However, because of insertion and detachment of lithium ions, degradation due to side reactions and expansion and contraction tend to occur. Further, since it is difficult for an interfacial layer to hold an electrolyte in voids, supply of metal ions from the negative electrode to the positive electrode tends to be hampered. Still further, since the negative electrode is completely covered with the interfacial layer, when lithium ions are completely inserted in the interfacial layer during charge, lithium tends to be hampered from diffusing into the negative electrode.

On the other hand, the metal porous body used in the present invention is a conductive porous body where metal ions are neither inserted nor detached. In addition, while hindering a concentration of a current on a negative electrode surface to hinder generation of dendrites, the degradation due to the side reactions and expansion and contraction such as described above can be hindered.

Further, since the metal porous body used in the present invention can hold the electrolyte in the voids, it is difficult to hamper supply of metal ions from the negative electrode to the positive electrode. For example, a liquid electrolyte or gel-like electrolyte can be impregnated in the voids in the metal porous body, or powders or the like of a polymer electrolyte or a solid electrolyte can be filled in the voids in the metal porous body, and ionic conductivity can thereby be ensured.

Although not bound by theory, one of reasons for current concentration on a negative electrode surface can be unevenness in electron conduction state due to a negative electrode surface state. Since the metal porous body used in the present invention has electron conductivity, disposing the metal porous body between the negative electrode layer and the electrolyte layer allows reduction in the unevenness in the electron conduction state on the negative electrode surface.

Since negative electrode metal ions are neither inserted in nor detached from the metal porous body, the metal porous body is hardly degraded and the current concentration hindering effect can be maintained. Further, since hindering a concentration of current on a negative electrode surface allows a negative electrode surface state to be hindered from degrading, and allows reduction in the unevenness in lithium concentration on the negative electrode surface. Thus, it is considered that generation of the dendrites can be reduced.

Thus, since the metal-air battery provided with the metal porous body according to the present invention can reduce the generation of the dendrites, highly efficient charge under high current density can be realized, and a high charge/discharge efficiency can be achieved.

In particular, when an air battery is formed with a material containing metal lithium in a negative electrode, in general the dendrites tend to be generated. However, also in this case, the metal-air battery provided with the metal porous body according to the present invention can hinder generation of the dendrites.

A material of the metal porous body is a conductive metal that is less likely to react with the negative electrode material, and is preferably made of SUS, Cu, Ni, Au, Pt or combinations thereof.

A thickness of the metal porous body is preferably 100 μm or less so that metal ion resistance does not become too high while the metal porous body hinders generation of the dendrite. The lower limit of the thickness of the metal porous body is not particularly limited as long as it is within a manufacturable range, for example, 1 μm or more.

The metal porous body has a pore diameter of preferably 1 mm or less, more preferably 500 μm or less, and still more preferably 250 μm or less so as to obtain the current concentration hindering effect of the negative electrode surface. Further, so that an electrolyte is filled in the metal porous body to obtain the metal ion conduction, the pore diameter is preferably 10 μm or more, more preferably 50 μm or more, and still more preferably 100 μm or more.

Further, in order to obtain the current concentration hindering effect on the negative electrode surface, the porosity (volume rate of pore) of the metal porous body is preferably 25% to 70%, and more preferably 30% to 50%.

The positive electrode layer may contain a conductive material. As the conductive material, a porous material is preferred but the conductive material is not limited thereto. Further, as the porous material, for example, carbon materials such as carbon can be cited. As the carbon, carbon black such as Ketjen black, acetylene black, channel black, furnace black, or mesoporous carbon, activated carbon, and carbon fiber can be cited, and a carbon material having a large specific surface area is preferably used. Still further, as the porous material, a porous material having a fine pore volume of nanometer order of about 1 mL/g is desirable. Preferably, the conductive material is contained in the positive electrode layer by 10 to 99% by mass.

The positive electrode layer may contain a binder. As the binder, for example, polytetrafluoroethylene (PTFE), polyvinylidene fluoride (PVdF), fluororesin such as fluororubber, thermoplastic resin such as polypropylene, polyethylene, and polyacrylonitrile, or styrene butadiene rubber (SBR) can be used. Preferably, the binder is contained in the positive electrode layer by 1 to 40% by mass.

The positive electrode layer may contain a redox catalyst, and, as the redox catalyst, metal oxides such as manganese dioxide, cobalt oxide, and cerium oxide, noble metals such as Pt, Pd, Au and Ag, transition metals such as Co, metal phthalocyanine such as cobalt phthalocyanine, and organic materials such as Fe polyphiline can be cited. Preferably, the redox catalyst is contained by 1 to 90% by mass in the positive electrode layer.

In the air battery according to the present invention, the electrolyte layer conducts metal ion conduction between the positive electrode layer and the negative electrode layer, and may contain a liquid electrolyte, a gel-like electrolyte, a polymer electrolyte, a solid electrolyte, or combinations thereof. The electrolyte can permeate fine pores in the positive electrode layer and can at least partially fill the pores in the positive electrode layer.

As the liquid electrolyte, a liquid that can exchange metal ions between the positive electrode layer and the negative electrode layer can be used, and may be a nonprotonic organic solvent, an ionic liquid, or the like.

Examples of the organic solvents include propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyl tetrahydrofuran, dioxane, 1,3-dioxolane, nitromethane, N,N-dimethylformamide, dimethylsulfoxide, sulfolane, γ-butylolactone, and grime.

As the ionic liquid, a highly oxygen radical resistant ionic liquid that can hinder a side reaction is preferable, and examples thereof include N, N-diethyl-N-methyl-N-(2-methoxyethyl)ammonium bis(trifluoromethanesulfonyl)amide (DEMETFSA), and N-methyl-N-propyl piperidinium bis(trifluoromethanesulfonyl)amide (PP13TFSA). Further, as the electrolytic solution, also combinations of the ionic liquid and the organic solvent can be used.

A support salt may be dissolved in the electrolytic solution. As the support salt, salts made of a lithium ion for example and the following anion: a halide anion such as Cl⁻, Br⁻, and I⁻; a boride anion such as BF₄⁻, B(CN)₄⁻, and B(C₂O₄)₂⁻; an amide anion or imide anion such as (CN)₂N⁻, [N(CF₃)₂]⁻, and [N(SO₂CF₃)₂]⁻; a sulphate anion or sulphonate anion such as RSO₃⁻ (hereinafter, R represents an aliphatic hydrocarbon group or aromatic hydrocarbon group), RSO₄⁻, R^{f}SO₃⁻ (hereinafter, R^{f} represents a fluorine-containing halogenated hydrocarbon group), and R^{f}SO₄⁻; a phosphorus-containing anion such as R^{f}₂P(O)O, PF₆⁻ and R^{f}₃PF₃⁻; an antimony-containing anion such as SbF₆; or an anion such as lactate, nitrate ion, trifluoroacetate, tris(trifluoromethanesulfonyl)methide can be used. Among these, for example, LiPF₆, LiBF₄, lithium bis(trifluoromethanesulfonyl)amide (LiN(CF₃SO₂)₂, hereinafter referred to as LiTFSA), LiCF₃SO₃, LiC₄F₉SO₃, LiC(CF₃SO₂)₃ and LiClO₄ can be cited, and LiTFSA is preferably used. Two or more kinds of such support salts may be combined. Further, an amount of the support salt added with respect to the electrolytic solution is preferably set in the range of about 0.1 to 1 mol/kg without particular limitation.

Further, as the electrolyte, a polymer electrolyte or a gel-like electrolyte may be used.

The polymer electrolyte that can be used in the electrolyte can be used together with, for example, the ionic liquid, and preferably contains a lithium salt and a polymer. As the lithium salt, a lithium salt that has been generally used in a lithium-air battery can be used without particular limitation. For example, lithium salts used as the support salt can be used. As the polymer, as long as it forms a complex with a lithium salt, there is no particular limitation. For example, polyethylene oxide can be cited.

The gel-like electrolyte that can be used in the electrolyte can be used together with, for example, the ionic liquid, and preferably contains a lithium salt, a polymer, and a non-aqueous solvent. As the lithium salt, the lithium salt described above can be used. As the nonaqueous solvent, as long as it can dissolve the lithium salt, there is no particular limitation. For example, the above-described organic solvents can be used. These nonaqueous solvents may be used singularly or in a combination of two or more kinds thereof. As the polymer, as long as it can be formed into a gel, there is no particular limitation. For example, polyethylene oxide, polypropylene oxide, polyacrylonitrile, polyvinylidene fluoride (PVdF), polyurethane, polyacrylate, and cellulose can be cited.

As the solid electrolyte material, a material that can be used as a solid electrolyte of an all solid batteries can be cited. For example, sulfide-based solid electrolytes such as Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅ or Li₂S—P₂S₅; oxide-based amorphous solid electrolytes such as Li₂O—B₂O₃—P₂O₅, Li₂O—SiO₂, Li₂O—B₂O₃, or Li₂O—B₂O₃—ZnO; crystalline oxides such as Li_{1.3}Al_{0.3}Ti_{0.7}(PO₄)₃, Li_{1+x+y}AₓTi₂₋ₓSi_{y}P_{3-y}O₁₂ (A represents Al or Ga, 0≦x≦0.4, 0<y≦0.6), [(Ba_{1/2}Li_{1/2})_{1-z}C_{z}]TiO₃ (B represents La, Pr, Nd, or Sm, C represents Sr or Ba, 0≦z≦0.5), Li₅La₃Ta₂O₁₂, Li₇La₃Zr₂O₁₂, Li₆BaLa₂Ta₂O₁₂, or Li_{3.6}Si_{0.6}P_{0.4}O₄; crystalline nitrides such as Li₃PO_{(4-3/2w)}N_{w} (w<1), or LiI, LiI—Al₂O₃, Li₃N, or Li₃N—LiI—LiOH can be used. The sulfide-based solid electrolyte can be preferably used since it has excellent lithium ion conductivity. Further, as the solid electrolyte of the present invention, also semi-solid polymer electrolytes such as polyethylene oxide, polypropylene oxide, polyvinylidene fluoride or polyacrylonitrile, which contain a lithium salt can be used.

In the metal-air battery according to the present invention, the electrolyte layer may have a separator. As the separator, there is no particular limitation, and, for example, polymer nonwoven fabrics such as polypropylene nonwoven fabric and polyphenylene sulfide nonwoven fabric, macroporous films of olefin resins such as polyethylene and polypropylene, or combinations thereof can be used. For example, an electrolyte layer may be formed by impregnating a separator with a liquid electrolyte.

The negative electrode layer contained in the metal-air battery of the present invention is a layer containing a negative electrode active material containing metal. As the negative electrode active material, for example, a metal, an alloy material, or a carbon material can be used. For example, alkali metals such as lithium, sodium, and potassium, alkaline earth metals such as magnesium, and calcium, the group 13 elements such as aluminum, transition metals such as zinc, iron, and silver, alloys containing these metals, or materials containing these metals, carbonaceous materials such as graphite, or further negative electrode materials that can be used in a lithium ion battery can be cited.

Further, when a material containing lithium is used as the negative electrode active material, as the material containing lithium, a carbonaceous material of lithium, an alloy containing lithium element, or a lithium oxide, nitride, or sulfide can be used. As the alloy containing lithium element, for example, lithium aluminum alloy, lithium tin alloy, lithium lead alloy, and lithium silicon alloy can be cited. As the metal oxide containing lithium element, for example, lithium titanium oxide can be cited. Further, as the metal nitride containing lithium element, for example, lithium cobalt nitride, lithium iron nitride, and lithium manganese nitride can be cited.

The negative electrode layer may further contain a conductive material and/or a binder. When the negative electrode active material is formed in foil, for example, the negative electrode layer can contain the negative electrode active material alone. When the negative electrode active material is in powder, the negative electrode layer can contain the negative electrode active material and the binder. As the conductive material and the binder, the same materials as those used in the positive electrode layer can be used.

As an exterior material that can be used in the metal-air battery according to the present invention, a material that can be usually used as an exterior material of an air battery such as a metal canister, a resin, or a laminate pack can be used.

In the exterior material, pores for feeding oxygen can be disposed at optional positions, for example, towards a contact surface between the positive electrode layer and air. As an oxygen source, dry air or pure oxygen is preferred.

The metal-air battery according to the present invention may contain an oxygen permeating membrane. The oxygen permeating membrane can be disposed, for example, on the positive electrode layer and on a side of a contact section with air on the opposite side from the electrolyte layer. As the oxygen permeating membrane, a water repellent porous membrane though which oxygen in air can permeate and which can prevent moisture from entering can be used. For example, a porous membrane made of polyester or polyphenylene sulfide can be used. A water repellent film may be separately disposed.

A positive electrode current collector may be disposed adjacent to the positive electrode layer. The positive electrode current collector can usually be disposed on the positive electrode layer and on a side of a contact section with air on the opposite side from the electrolyte layer, but may be disposed between the positive electrode layer and the electrolyte layer. As the positive electrode current collector, as long as it is a material that has been used as a conventional current collector such as carbon paper, a porous structure such as metal mesh, a net-work structure, fiber, and nonwoven fabric, it can be used without particular limitation. A metal mesh formed of, for example, SUS, nickel, aluminum, iron, or titanium can be used. As the positive electrode current collector, also a metal foil having oxygen feeding pores can be used.

A negative electrode current collector can be disposed adjacent to the negative electrode layer. As the negative electrode current collector, as long as it is a material that has been used as a conventional negative electrode current collector such as a conductive substrate having a porous structure or a poreless metal foil, it can be used without particular limitation. A metal foil formed of, for example, copper, SUS, or nickel can be used.

A shape of the metal-air battery according to the present invention is not particularly limited as long as it is a shape having oxygen inlet pores. Any desired shape such as cylinder, rectangular, button, coin, or flat shape can be adopted.

The metal-air battery according to the present invention can be used as a secondary battery but may be used also as a primary battery.

The positive electrode layer, electrolyte layer, and negative electrode layer contained in the metal-air battery according to the present invention can be formed according to any method among conventional methods. When a positive electrode layer containing carbon particles and a binder is formed for example, an appropriate amount of a solvent such as ethanol is added to predetermined amounts of carbon particles and the binder and mixed, the resulted mixture is rolled to a predetermined thickness by a roll press, dried and cut, and a positive electrode layer can thereby be formed. Subsequently, the positive electrode current collector is pressure bonded, dried by heating in vacuum, and a positive electrode layer combined with the current collector can thereby be obtained.

As an alternative method, an appropriate amount of a solvent is added to predetermined amounts of the carbon particles and the binder, mixed to obtain a slurry, the slurry is coated on a base material and dried, and a positive electrode layer can thereby be obtained. The obtained positive electrode layer may be press molded if desired. As a solvent for obtaining a slurry, acetone, NMP, and the like which have a boiling temperature of 200° C. or less can be used. As a coating process of the slurry on a base material of the positive electrode layer, a doctor blade method, a gravure transferring method, an ink-jet method, and the like can be cited. Although the used base material is not particularly limited, a current collector plate used as a current collector, a base material having film-like flexibility, a hard base material and the like can be used. For example, base materials such as a SUS foil, a polyethylene terephthalate (PET) film, and TEFLON (registered trade mark) can be used. The methods of forming the negative electrode layer and the electrolyte layer are the same as above.

### Preparation of Cell

### Example 1

Ninety percent by mass of Ketjen black (ECP-600JD, manufactured by Ketjen Black International), 10% by mass of a polytetrafluoroethylene (PTFE) binder (F-104, manufactured by Daikin Industries Ltd.), and an appropriate amount of ethanol as a solvent were mixed, and a mixture was obtained. The resulted mixture was rolled by a roll press, dried and cut, and a positive electrode layer having a diameter of 18 mmφ and a thickness of 130 μm was thereby obtained.

Using a 100 mesh made of SUS304 (manufactured by Nilaco Corporation) as a current collector, the positive electrode layer and the current collector were pressure bonded, subsequently heated and vacuum dried, thereby the current collector was assembled with the positive electrode layer.

Using N,N-diethyl-N-methyl-N-(2-methoxyethyl)ammonium bis(trifluoromethanesulfonyl)amide (DEMETFSA, manufactured by Kanto Chemical Co., INC.) as a solvent, lithium bis(trifluoromethanesulfonyl)amide (LiTFSA, manufactured by Kishida Chemical Co., Ltd.) that is a lithium salt was dissolved so as to obtain a concentration of 0.35 mol/kg by mixing at 25° C. for 12 hours under Ar atmosphere, and an electrolyte solution was thereby prepared.

As the metal porous body, a SUS mesh of 100 mesh (pore diameter: 154 μm, pore volume rate: 35%), having a diameter of 22 mm and a thickness of 100 μm (manufactured by Nilaco Corporation) was prepared.

As the negative electrode layer, a metal lithium foil having a diameter of 22 mφ and a thickness of 500 μm (manufactured by Honjo Metal Co., Ltd.) was prepared, and adhered to the negative electrode current collector made of SUS 304 plate having a diameter of 22 mm and a thickness of 2 cm (manufactured by Nilaco Corporation).

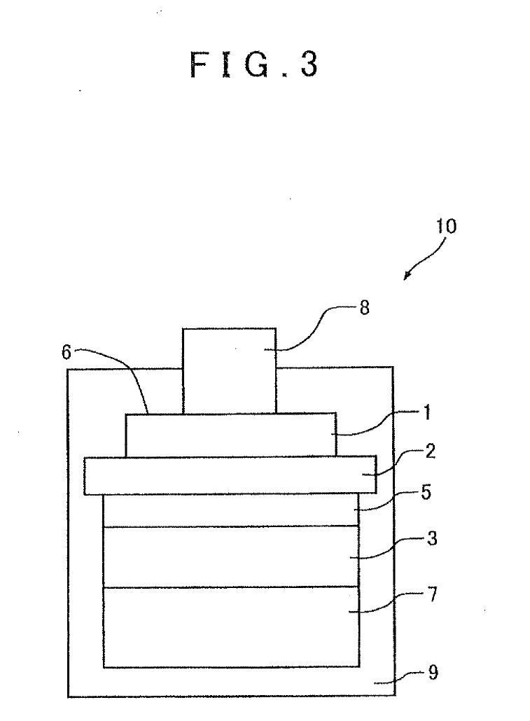

As shown in FIG. 3, under Ar atmosphere, in a hermetically sealed metal container 9 where an insulating resin was interposed between the positive electrode layer and the negative electrode layer so as to insulate those from each other such that a negative electrode current collector 7 and the negative electrode layer 3 were disposed with the negative electrode current collector being disposed on a lower side. On the negative electrode layer 3 the metal porous body 5 was disposed, and a polypropylene nonwoven fabric as a separator having a thickness of 40 μm and a diameter of 28 mmφ was further disposed. One hundred μL of the prepared electrolytic solution was injected to impregnate in the separator to form the electrolyte layer 2. Subsequently, the positive electrode layer 1 and a positive electrode current collector 6 were assembled so as to allow the electrolytic solution to further permeate a gap in the positive electrode (air electrode) layer 1. Accordingly, an electrochemical cell 10 for evaluation with a gas reservoir was prepared.

Subsequently, the electrochemical cell 10 was put in a glass desiccator (500 mL specifications) provided with a cock for gas substitution, and an atmosphere in the glass desiccator was changed by use of pure oxygen (manufactured by Taiyo Nippon Sanso Corporation, 99.9%) into an oxygen atmosphere.

### Comparative Example 1

An evaluation cell was prepared in the same manner as Example 1 except that the negative electrode layer 3 and the electrolyte layer 2 were adjacently disposed without disposing the metal porous body therebetween and put in the glass desiccator, and an atmosphere in the glass desiccator was changed into an oxygen atmosphere.

(Measurement of Initial Charge/Discharge Efficiency of Cell)

On evaluation cells prepared in Example 1 and Comparative Example 1, a charge/discharge test was conducted under the following condition, and an initial charge/discharge efficiency was measured.

The evaluation cells put into the glass desiccator were left to stand in a thermostat set at 60° C. for 3 hours before starting the test. Subsequently, using a charge-discharge I-V measurement apparatus multi-channel potentiostat/galvanostat VMP3 (manufactured by Bio-Logic Science Instruments), the evaluation cells underwent discharge up to 2.30 V under conditions of 60° C., pure oxygen, 1 atmosphere, and a positive electrode area of 2.5 cm² and 0.2 mA/cm². Subsequently, the evaluation cells underwent charge at 0.1 mA/cm² up to 3.85 V

The initial charge/discharge efficiency was calculated according to the following equation.

Initial charge/discharge efficiency=(charge capacity in the first cycle)/(discharge capacity in the first cycle).

Table 1 shows initial charge/discharge efficiencies of the evaluation cells prepared according to Example 1 and Comparative Example 1.

TABLE 1
Initial charge current density and charge/discharge efficiency

| | Charge current | Charge/discharge efficiency |
|---|---|---|
| | density (mA/cm²) | in the first cycle (%) |
| Example 1 | 0.1 | 99 |
| Comparative Example 1 | 0.1 | 10 |

Compared with the fact that the initial charge/discharge efficiency of the evaluation cell prepared according to Comparative Example 1 was 10%, the initial charge/discharge efficiency of the evaluation cell prepared according to Example 1 was 99%. That is, a higher charge/discharge efficiency was obtained.

What is claimed is:

1. A metal-air battery comprising:
a positive electrode layer;
a negative electrode layer;
an electrolyte layer interposed between the positive electrode layer and the negative electrode layer; and
a metal porous body interposed between the negative electrode layer and the electrolyte layer.

2. The metal-air battery according to claim 1, wherein the metal porous body is made of, SUS, Cu, Ni, Au, Pt or combinations thereof.

3. The metal-air battery according to claim 1, wherein a pore diameter of the metal porous body is 10 μm to 1 mm.

4. The metal-air battery according to claim 1, wherein the porosity of the metal porous body is 25% to 70%.

5. The metal-air battery according to claim 1, wherein the negative electrode layer contains a material containing lithium.

6. The metal-air battery according to claim 1, wherein the electrolyte layer contains a separator, and the metal porous body is provided between the negative electrode layer and the separator.
